(19) United States
(12) Patent Application Publication
(10) Pub. No.: US 2002/0012209 A1
(43) Pub. Date: Jan. 31, 2002

(54) Magnetoresistive head

(76) Inventors: Satoshi Ajiki, Yamagata (JP); Tsuyoshi Ishii, Yamagata (JP); Koichi Hosoya, Yamagata (JP)

Correspondence Address: McGuire Woods, 1750 Tysons Boulevard, Suite 1800, Tysons Corner, McLean, VA, 22102-3915, US

(21) Appl. No.: 09/876,050

(22) Filed: Jun. 8, 2001

(30) Foreign Application Priority Data
Jun. 12, 2000 (JP) P.2000-175642

(51) Int. Cl. G11B 5/39

(52) U.S. Cl. 360/327.3; 360/324.12

(57) ABSTRACT

A magnetoresistive element has a first end face for detecting an external magnetic field and a second end face which is opposed to the first end face. A pair of vertical bias layers sandwich the magnetoresistive element so as to expose the first and second end faces, to apply a bias magnetic field to the magnetoresistive element. Each of the vertical bias layers includes a face, which is continuous and flush with the second end face, having a length of 1.5 μm or greater. Alternatively, each of the vertical bias layers includes a face which is continuous with the second end face, and inclined by 0 to 45 degrees with respect to the second end face.

### BACKGROUND OF THE INVENTION

The present invention relates to a magnetoresistive head which has a magnetoresistive element as a magnetic sensitive element and also has a pair of vertical bias layers which applies vertical bias magnetic field to the magnetoresistive element.

A magnetoresistive head (hereinafter simply called as an MR head) having a magnetoresistive element (hereinafter simply called as an MR element) as a magnetic sensitive element is known as a magnetic head. The MR head detects external magnetic field in a manner that the resistance value of the MR element thereof changes depending on the presence of the external magnetic field and the change of the resistance value of the MR element is detected as a change of voltage.

As the MR elements, there are known an AMR element representing anisotropic magnetoresistive effect and a GMR element representing giant magnetoresistive effect represented by a spin valve type element (SV element). In each of these MR elements, the resistance value change characteristics with respect to the change of external magnetic field is preferably linear. In other words, since the resistance value changes linearly in accordance with the change of external magnetic field, the MR head can detect the external magnetic field with an excellent sensitivity. Thus, the MR head detects external magnetic field in a state that bias magnetic field for linearly operating the MR element is applied thereto. That is, the MR head is provided with bias layers so as to sandwich the MR element.

An example of the configurations of related MR heads will be shown with reference to FIGS. 6 and 7. As shown in the figures, the MR head includes an MR element 100, a pair of vertical bias layers 101 disposed both sides in the longitudinal direction of the MR element 100, and conductors 102 disposed on the respective vertical bias layers 101. Incidentally, in FIGS. 6 and 7, other constituent members of the MR head are omitted.

In the MR head configured in this manner, bias magnetic field generated in a direction shown by an arrow a in FIG. 6 between the pair of vertical bias layers 101 is applied to the MR element 100. The MR element can linearly change the resistance value thereof with respect to the change of the external magnetic field by being applied with the bias magnetic field in the arrow direction a.

However, as described above, according to such an MR head, even when the bias magnetic field is applied, there arises a case that the MR element 100 does not operate stably and reproduced waveform is distorted largely. This is considered that the bias magnetic field applied to the MR element 100 does not exhibit desired magnetic characteristics. For example, it is considered that bias magnetic field distorted by magnetic field generated at the areas shown by c in FIG. 6 is applied to the MR element 100. Thus, the related MR head has a problem that even if bias magnetic field is applied to the MR element, reproduced waveform is distorted, so that the reliability is low in a view point of reproduced characteristics.

### SUMMARY OF THE INVENTION

Accordingly, the invention has been made in view of the aforesaid circumstance, and an object of the invention is to provide an MR head which can apply desired bias magnetic field to an MR element to thereby output excellent reproduced waveform.

In order to attain the aforesaid object, the inventors of the invention has investigated the MR heads and found that it is possible to preferably control the magnetic characteristics of bias magnetic field due to the configuration of vertical bias layers to thereby complete the invention.

Specifically, there is provided a magnetoresistive head, comprising:

a magnetoresistive element, having a first end face for detecting an external magnetic field and a second end face which is opposed to the first end face; and

a pair of vertical bias layers, sandwiching the magnetoresistive element so as to expose the first and second end faces, to apply a bias magnetic field to the magnetoresistive element, each of the vertical bias layers including a face, which is continuous and flush with the second end face, having a length of 1.5 μm or greater.

In this configuration, the bias magnetic field applied to the magnetoresistive element can be set to have desired magnetic characteristics. Thus, the magnetoresistive head can surely prevent the generation of noise component.

Alternatively, there is provided a magnetoresistive head, comprising:

a magnetoresistive element, having a first end face for detecting an external magnetic field and a second end face which is opposed to the first end face; and

a pair of vertical bias layers, sandwiching the magnetoresistive element so as to expose the first and second end faces, to apply a bias magnetic field to the magnetoresistive element, each of the vertical bias layers including a face which is continuous with the second end face, and inclined by 0 to 45 degrees with respect to the second end face.

Also in this configuration, the bias magnetic field applied to the magnetoresistive element can be set to have desired magnetic characteristics. Thus, the magnetoresistive head can surely prevent the generation of noise component.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a plan view of an essential portion of an MR head according to a first embodiment of the invention;

FIG. 2 is a perspective view of the essential portion of the MR head shown in FIG. 1;

FIG. 3 is a perspective view of an essential portion of a modified example of the MR head shown in FIG. 1;

FIG. 4 is a perspective view of an essential portion of an MR head according to a second embodiment of the invention;

FIG. 5 is a plan view of the essential portion of the MR head shown in FIG. 4;

FIG. 6 is a plan view of an essential portion of a related MR head; and

FIG. 7 is a perspective view of the essential portion of the related MR head.

### DETAILED DESCRIPTION OF THE PREFERRED EMBODIMENTS

Preferred embodiments of a magnetoresistive head according to the invention will be explained in detail with reference to the accompanying drawings.

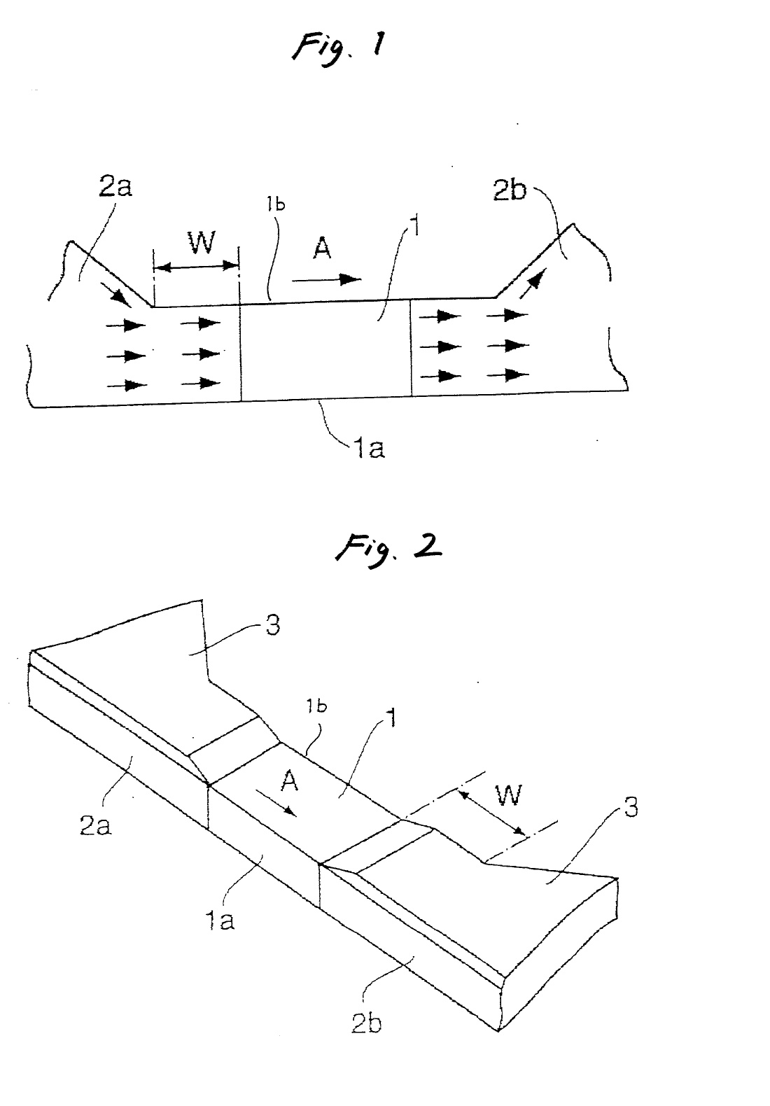

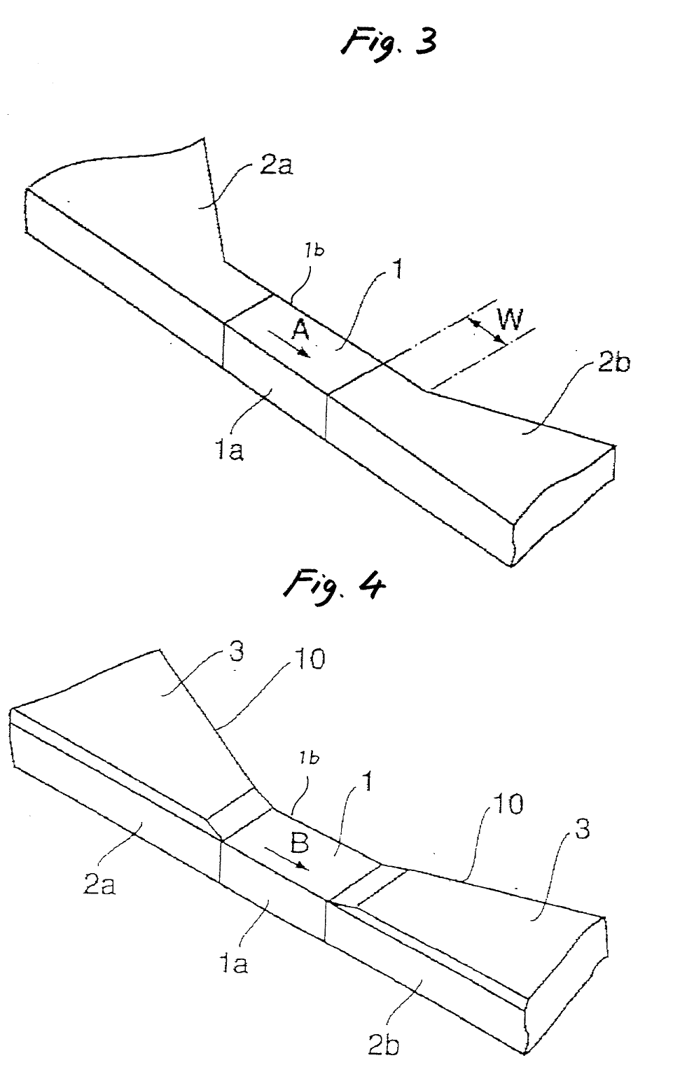

As shown in FIGS. 1 and 2, the magnetoresistive head (hereinafter, simply called as an MR head) shown as a first embodiment is provided with a magnetoresistive element 1 (hereinafter, simply called as an MR element 1) for detecting external magnetic field, a pair of vertical bias layers 2a, 2b disposed at the both longitudinal end portions of the MR element 1 so as to sandwich the MR element 1, and conductors 3 disposed on the pair of the vertical bias layers 2a, 2b so as to supply a sense current to the MR element 1.

Incidentally, FIGS. 1 and 2 show only the essential portion of the MR head of the embodiment, and a lateral bias layer, a magnetic separation layer disposed below the MR element 1 are omitted, for example.

The MR element 1 is formed to have a predetermined thickness and one major face (a top face, in this embodiment) side thereof is configured in an almost rectangular shape. An MR element formed of magnetic film such as FeNi may be employed as the MR element 1, for example. The MR element 1 may be either one of an AMR element representing anisotropic magnetoresistive effect and a GMR element representing giant magnetoresistive effect represented by a spin valve type element (SV element). In the MR head, the MR element 1 is arranged to expose its end face 1a to the outside thereby to detect external magnetic field applied from the end face 1a side. That is, in the MR element 1, the end face 1a serves as an external magnetic field detection face.

On the other hand, each of the pair of the vertical bias layers 2a, 2b is configured to have a portion which is flush with a face 1b at the opposite side of the external magnetic field detection face 1a. Each of the portions made flush is arranged to have a length of 1.5 μm or more. That is, in each of the pair of the vertical bias layers 2a, 2b, the size of a portion designated by W in FIGS. 1 and 2 is set to be 1.5 μm or more.

In the MR head configured in this manner, the MR element 1 detects the external magnetic field in a state that bias magnetic field generated between the pair of the vertical bias layers 2a, 2b is applied to the MR element 1. At this time, constant current (sense current) is supplied to the MR element 1 from the pair of the conductors 3. When the external magnetic field is applied to the MR element 1, the MR element changes its resistance value with respect to the sense current. Thus, the MR head can detect the change of the resistance value of the MR element 1 as the change of the voltage with respect to the sense current to thereby detect the external magnetic field.

In this case, since the size of each of the portions represented by W in the pair of the vertical bias layers 2a, 2b is 1.5 μm or more, bias magnetic field is generated uniformly only in a direction shown by an arrow A in FIGS. 1 and 2. Thus, the uniform bias magnetic field in the arrow A direction can be applied to the MR element 1.

If the size of each of the portions represented by W in FIGS. 1 and 2 is less than 1.5 μm, unexpected magnetic field generated due to the configuration of the pair of the vertical bias layers 2a, 2b is applied to the MR element 1. Since the unexpected magnetic field generated at this time is not directed in the arrow A direction, such unexpected magnetic field will be a cause of noise component when applied to the MR element 1. In this case, the MR head outputs distorted reproduction waveform due to the unexpected magnetic field generated from the pair of the vertical bias layers 2a, 2b, so that the MR head is deteriorated in its reliability.

In contrast, in the MR head according to the embodiment, since the size of each of the portions represented by W is 1.5 μm or more, even if unexpected magnetic field is generated, the MR element 1 is not greatly influenced by such unexpected magnetic field. In other words, in the MR head, since the bias magnetic field applied to the MR element 1 is restricted only in the predetermined direction, reproduced waveform can not be distorted and good reproduction output can be obtained. Therefore, the MR head is quite excellent in reliability.

Incidentally, in the embodiment, the MR head may be arranged not to dispose the conductors 3 on the pair of the vertical bias layers 2a, 2b but to employ the pair of the vertical bias layers 2a, 2a also as electrodes.

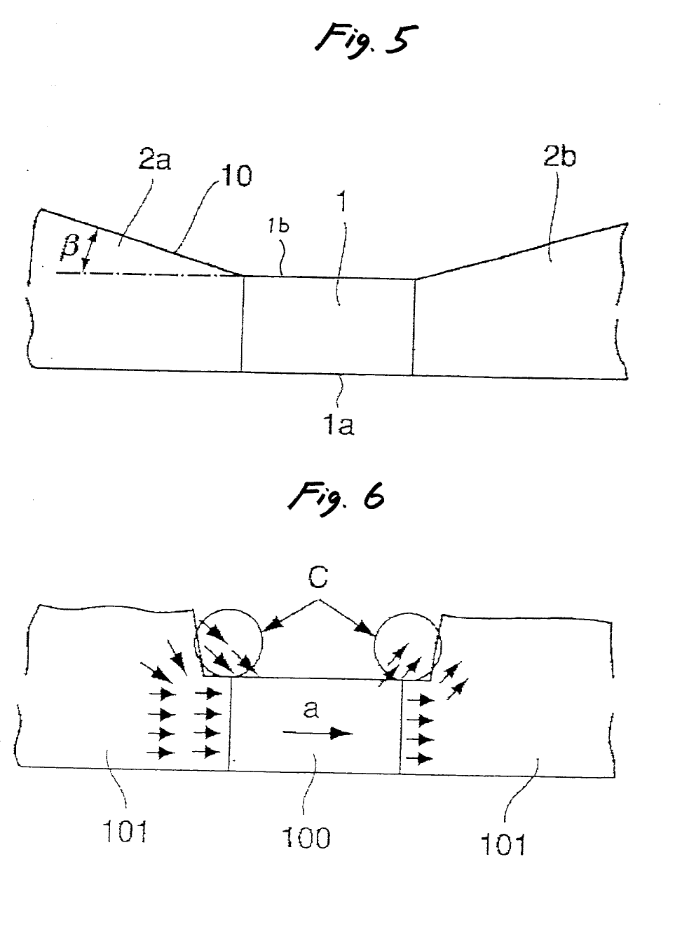

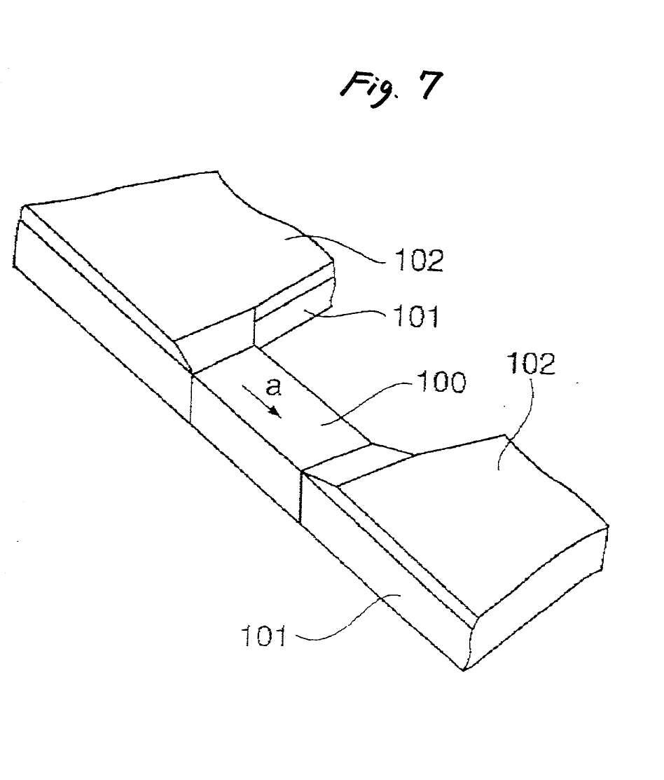

The MR head according to a second embodiment is similar to the first embodiment in its configuration in a point that the MR head includes an MR element 1, a pair of vertical bias layers 2a, 2b and conductors 3, as shown in FIGS. 4 and 5. In the MR head shown in the second embodiment, each of the pair of vertical bias layers 2a, 2b has a slanted face 10 inclined by 0 to 45 degrees with respect to an end face 1b at the opposite side to the external magnetic field detection face 1a of the MR element 1. That is, in the MR head, the MR element 1 is sandwiched by the pair of vertical bias layers 2a, 2b having the slanted faces 10. Each of the slanted faces 10 is restricted to have the angle (angle shown by β in FIG. 5) of 0 to 45 degrees with respect to the end face 1b.

In the MR head thus configured, also the MR element 1 changes its resistance value in accordance with external magnetic field, and the change of the resistance value of the MR element is detected as the change of a voltage with respect to a constant sense current supplied to the MR element 1 to thereby detect the external magnetic field. In this case, since the angle β of the MR head is restricted in the range of 0 to 45 degrees, the bias magnetic field can be generated only in a direction shown by an arrow B in FIG. 4.

If the angle β is out of the range of 0 to 45 degrees, the magnetic field generated from the end face of the slanted faces 10 will be directed in a direction other than that shown by the arrow B. Thus, if the angle β is out of the range of 0 to 45 degrees, the bias magnetic field directed in the direction other than that shown by the arrow B in FIG. 4 is applied to the MR element 1, so that the operation of the MR element 1 is made unstable. As a result, if the angle β is out of the range of 0 to 45 degrees, the reproduced waveform is distorted and so excellent reproduction characteristics can not be obtained.

In contrast, according to the MR head shown in the second embodiment, since the angle β is within the range of 0 to 45 degrees, desired bias magnetic field can be applied to the MR element 1, so that excellent reproduction characteristics can be obtained. Thus, the MR head is excellent in the reliability in a view point of the reproduction characteristics.

As described above in detail, the magnetoresistive head according to the invention can control the bias magnetic field applied to the MR element in a desired direction. Thus, the magnetoresistive head exhibits excellent reproduction characteristics and is excellent in the reliability in a view point of the reproduction characteristics.

What is claimed is:

1. A magnetoresistive head, comprising:
a magnetoresistive element, having a first end face for detecting an external magnetic field and a second end face which is opposed to the first end face; and
a pair of vertical bias layers, sandwiching the magnetoresistive element so as to expose the first and second end faces, to apply a bias magnetic field to the magnetoresistive element, each of the vertical bias layers including a face, which is continuous and flush with the second end face, having a length of 1.5 μm or greater.

2. A magnetoresistive head, comprising:
a magnetoresistive element, having a first end face for detecting an external magnetic field and a second end face which is opposed to the first end face; and
a pair of vertical bias layers, sandwiching the magnetoresistive element so as to expose the first and second end faces, to apply a bias magnetic field to the magnetoresistive element, each of the vertical bias layers including a face which is continuous with the second end face, and inclined by 0 to 45 degrees with respect to the second end face.

3. The magnetoresistive head as set forth in claim 2, wherein a portion of the face of the vertical bias layer which is continuous with the second end face is flush with the second end face and has a length of 1.5 μm or greater.
